(19) United States
(12) Patent Application Publication
(10) Pub. No.: US 2002/0147974 A1
(43) Pub. Date: Oct. 10, 2002

(54) Networked installation system for deploying systems management platforms

(76) Inventor: Michael J. Wookey, Santa Clara, CA (US)

Correspondence Address: William J. Kubida, Esq., Hogan & Hartson, LLP, Suite 1500, 1200 17th Street, Denver, CO, 80202, US

(21) Appl. No.: 09/780,038

(22) Filed: Feb. 9, 2001

(51) Int. Cl. G06F 9/445; G06F 15/177

(52) U.S. Cl. 717/176; 709/220

(57) ABSTRACT

A method, and installation system for implementing such method, is provided for remotely installing systems management software on a host. The method includes communicatively linking an installation station with the host, downloading a survey script on the host, executing the survey script to automatically gather computing environment information, and transmitting to the installation station the environment information. The installation station transmits to the host a tool for automatically installing the systems management software. A payload comprising the systems management software is transmitted from the installation station to the host. The payload is selected to suit the environment information. The installation tool installs the payload on the host and automatically configures the installed software for the detected host environment. The environment information includes hardware and software configuration information, identification of modules for monitoring the host, thresholds based on configuration of the host, and installation commands to run during payload installation.

### BACKGROUND OF THE INVENTION

1. Field of the Invention.

The present invention relates, in general, to software or package distribution and installation in a distributed computer network, and, more particularly, to a system and method for rapidly deploying remote service agents and/or system management platforms onto existing and operating host computer systems with the deployed software packages or payloads being accurately and dynamically configured for the host computer system through the cooperative workings of discovery and installation tools operating on the host computer system and an installation mechanism operating at a remote services station computer system.

2. Relevant Background.

With the growth of the Internet and other digital communications networks, networked computer systems are becoming increasing common with nearly every organization having a complex networked environment of computing resources utilizing a wide variety of software, hardware, and operating systems. Information Technology (IT) organizations need to perform automated and sometimes remote managing, monitoring, servicing, and updating of computers. These functions are often performed from one or more central service facilities or stations with the use of software agents operating on the computers themselves. To meet this growing need for network management, a service provider typically will load a software toolset or agent (e.g., a systems management platform such as SunMC™) onto a host computer within a customer's computer system. The systems management platform then operates to manage the customer's computer system by controlling software distribution, version control, backup and recovery, virus protection, network management (e.g., network address allocation and the like), configuration management control, application monitoring, event and alarm management, and many other functions.

While these systems management platforms can provide many operating advantages in networked enterprises, proper installation and initial configuration of systems management platforms within customers' host computers has proven to be a difficult, time consuming, and expensive task for IT organizations. Current industry estimates indicate that the IT consulting fees for installing and initially debugging a systems management platform placed within a customer's computer system can be six times the cost of procuring the software and higher. Consequently, the IT and computer industries continue to search for ways of improving the installation process and reducing costs to gain further customer acceptance for these products and services.

The installation of systems management platforms or software creates numerous problems that need to be addressed by the platform provider. For example, the platform provider typically knows very little about a customer's computing environment prior to and at the time of the installation. Additionally, customers may change or add to the network environment between the time the request is made for the platform and installation is begun. To work properly once installed, the platform generally needs to be adapted to suit the host computer configuration and the customer's network environment by selecting a platform compatible with the operating system, selecting appropriate agents or modules to monitor the existing hardware, and making other changes necessary to provide a fully functioning systems management platform upon and after installation. Existing installation techniques are normally based on the customer's site and within the host computer and involve the manual collection of electronic information for the customer's networked system. Once the information is collected, the software is installed and initially configured manually by a team of onsite IT personnel. The software is executed and further configured as a part of an iterative process attempting to remove bugs and glitches and to force the installed software to better suit the unique environment of the customer. As will be understood by those in the computer industry, inserting a software package into a running, networked computer environment is challenging and is often limited by the customer's change controls and security systems. As a result, these onsite installations can be time consuming and expensive.

Additionally, proper installation under these conventional methods is very dependent upon the skill and knowledge of the IT personnel installing and configuring the systems management platform (i.e., the installers). Unfortunately, the level of knowledge varies significantly between installers. Often, the installers are not fully literate in the particular systems management software that they are installing. Additionally, the installers may not be experienced or even understand the platform's programming language or the operating system of the customer's host computer.

Experience with platform installation has shown that customers are often disappointed with the installation costs and the resulting operation of the platform. Installation resources including personnel and equipment are often limited by budgetary constraints and time. The installers generally attempt to understand the customer's system and the host computer's operating environment, but due to cost and time restrictions, configuration is only performed with an eye toward getting the platform up and running. Little effort or time is placed on insuring that the configuration fully suits the customer's computing environment let alone their long-term computing and business goals. Another ongoing problem is that an installation process that is effective on a particular host may be inappropriately applied to other differently configured hosts or applied to multiple host environments without proper adaptation by the installers, both of which typically result in ineffective operation or platform failures that have to be resolved. As a result, installation and configuration of systems management platforms are presently technically challenging tasks that are difficult to complete in a timely or cost-effective manner with customer-accepted results.

Hence, there remains a need for an improved method and system for installing and configuring systems management software or platforms in varying operating environments. Such a method and system preferably would provide for deployment of systems management platforms with more accurate configuration for particular host devices and customer environments while also significantly increasing the speed of installation and configuration and lowering the cost and intrusiveness to the end customer.

### SUMMARY OF THE INVENTION

The present invention addresses the above discussed and additional problems by providing a network-based systems management installation system that is capable of analyzing a host computer device, selecting a software payload (i.e., a set of software applications and/or modules that define a systems management platform), delivering the software payload to the host, installing the software payload on the host, and dynamically configuring the software payload based on the host analysis.

According to one aspect of the invention, a method is provided for remotely installing systems management software on a host device. In contrast to prior art installation methods, the method is not host-based. Rather, the method involves communicatively linking an installation station with the host device and receiving at the installation station computing environment information for the host device. The installation station then transmits an installation tool configured for automatically installing the systems management software to the host device. A software payload comprising the systems management software is then transmitted from the installation tool to the host device.

In one embodiment, the payload contents are selected based on the computing environment information. Next, the installation tool acts automatically to install the software payload on the host device and to configure the installed software payload based on the computing environment information. The computing environment information is utilized to select and configure the software payload and may include, among other pieces of information, host hardware and software configuration, identification of modules for monitoring the host device, thresholds based on configuration of the host device, and installation commands to be run during payload installation.

According to another aspect of the invention, a method of deploying systems management software to multiple managed hosts within a network. The method includes positioning an installation station within the network in communication with at least a first and a second one of the hosts. A survey tool from the installation station is downloaded at the first and the second hosts. The hosts then execute the survey tool to gather environment information for the first and the second host and to create output files based on the gathered information. An installation tool is also downloaded from the installation station at the first and second hosts. The output files are transmitted to the installation station that responds by transferring a payload of the systems management software to both the first and second hosts. The installation tool then acts at each of the hosts to install the payload on the first and second hosts.

Significantly, the installation station establishes active installation sessions managed by a session manager to monitor and control the multiple installation sessions. Preferably, the method provides for concurrent installation of systems management software on multiple hosts with the installed software, at least in some embodiments, being selected based on the output files and being further adapted or modified to suit the particular host based on the environment information.

According to yet another aspect of the invention, a networked method is provided for automatically deploying and installing agent software in a network computer device. An installation station is communicatively linked via a communications network to the network computer device. A survey script is downloaded from the installation device onto the network computer device. The survey script is executed on the network computer device to automatically create an output file defining a computing environment for the network computer device. The method continues with downloading an installation Daemon from the installation station onto the network computer device, and then using the installation Daemon to retrieve the output file and transfer a copy to the installation station. In response, the installation station acts to transfer the agent software to the network computer device. The installation Daemon automatically receives and installs the agent software on the network computer device. In this manner, environment information and installation of the agent software are automated functions that require no operator intervention for successful completion.

### BRIEF DESCRIPTION OF THE DRAWINGS

FIG. 1 illustrates a systems management software installation system according to the present invention in an exemplary networked, client-server environment with an installation station linked to managed hosts;

FIG. 2 is a box diagram of one embodiment of the installation service device of FIG. 1 illustrating included components that provide dynamic and interactive downloading and configuration of systems management software based on the hardware and software configuration of a particular managed host; and

FIG. 3 is a flow diagram showing the acts and functions carried out by the combined and cooperative operation of the installation service device, downloaded tools on the managed hosts, and other components of the installation system of FIG. 1.

### DETAILED DESCRIPTION OF THE PREFERRED EMBODIMENTS

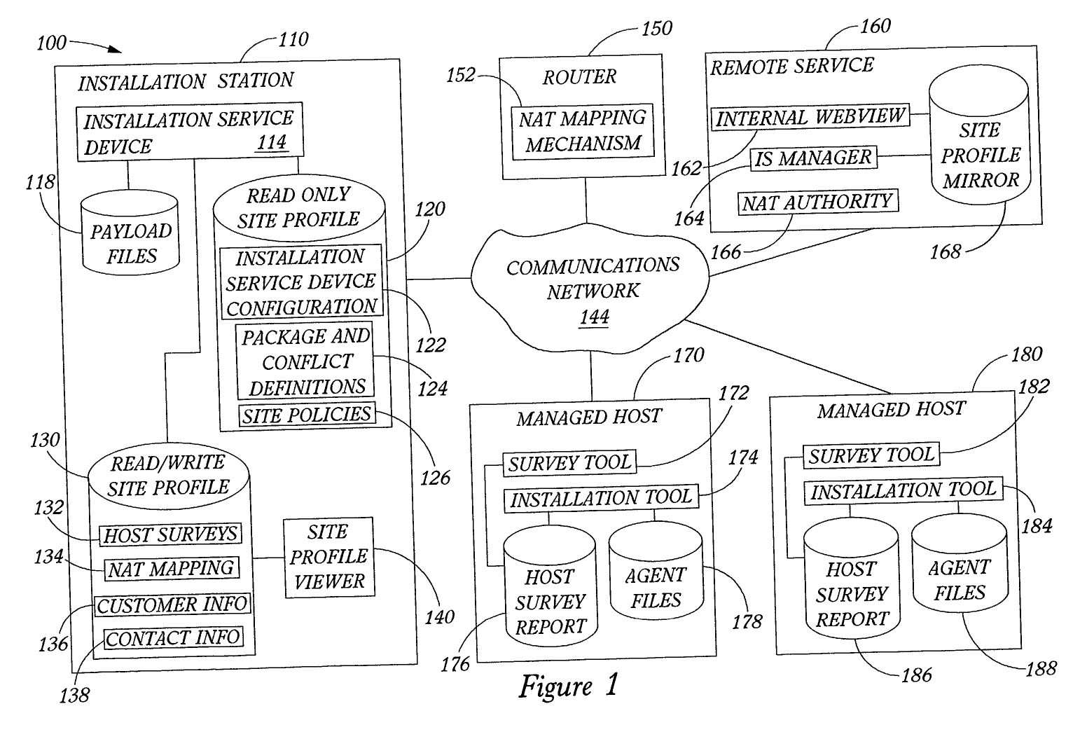

FIG. 1 illustrates one embodiment of a systems management software installation system 100 useful for remotely distributing and loading systems management software (e.g., the agent and/or other software portions of a platform) with the particular software payload being installed on each computer device being dynamically and selected and configured to better suit that computer device. The receiving computer devices will be referred to as managed hosts in the following discussion and as will be appreciated, may comprise a variety of single computer devices or, more likely, a system of computing devices that operate together and create a unique computing environment. Significantly, the installation system 100 is adapted to remotely retrieve information from the managed hosts to determine the computing environment and then to select a software payload for each particular host and to configure the delivered and loaded payload based on this environment information. In this manner, the installation system 100 can rapidly deploy systems management software to numerous managed hosts from a remote location (i.e., an installation station) that is tailored to properly function on the managed host. The invention minimizes the need for teams of IT personnel to travel to each managed host site to configure and debug installed systems management software.

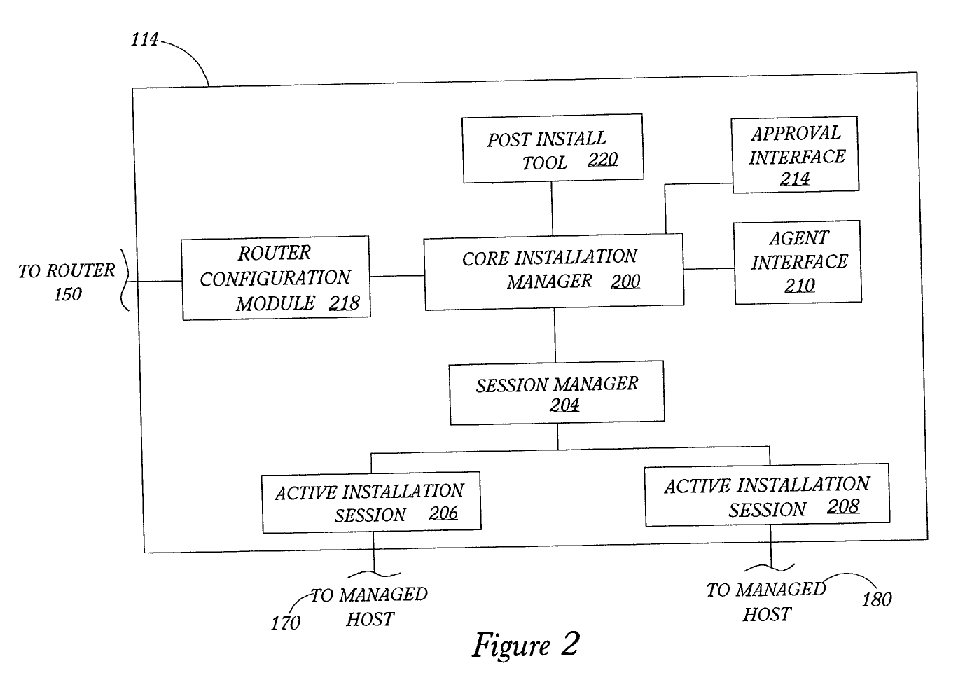

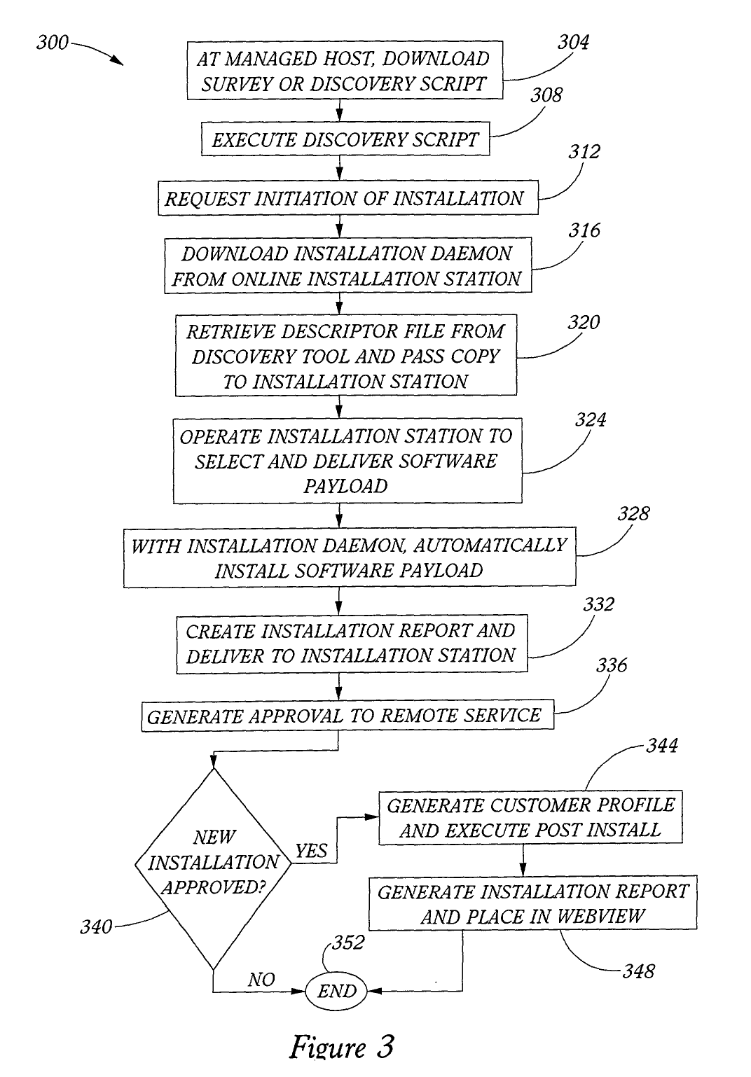

The functions and operation of the installation system 100 are described in a client/server, de-centralized computer network environment with the software payloads and environment information being transmitted over a digital communications network. While this is a highly useful implementation of the invention, those skilled in the computer and networking arts will readily appreciate the features of the invention are transferable to many data communication systems that utilize numerous and varied data transfer techniques including transfer of data and software via media storage devices. These variations to the exemplary installation system 100 are considered within the breadth of the following disclosure and claims. The description of the installation system 100 begins with a brief discussion of the components making up the system 100 with reference to FIGS. 1 and 2 and continues with a fuller description of the operation of each component in connection to the operation of the installation system 100 with reference to FIG. 3.

As illustrated, the installation system 100 includes an installation station in communication a router 150, a remote service 160, and managed hosts 170, 180 via communications network 144. In the following discussion, network devices, such as the installation station 110 and the managed hosts 170, 180, will be described in relation to their functions rather than as particular electronic devices and computer architectures. To practice the invention, these computer devices and network devices may be any devices useful for providing the described functions, including well-known data processing and communication devices and systems such as personal computers with processing, memory, and input/output components. Many of these network devices may be server devices configured to maintain and then distribute software and data over the data communications network 144. The communication links between the components 110, 150, 160, 170, 180 and the communications network 144 may be any suitable data communication links, wired or wireless, for transferring digital data between two electronic devices (e.g., a LAN, a WAN, an Intranet, the Internet, and the like). In a preferred embodiment, data is communicated in digital format following standard protocols, such as TCP/IP, but this is not a limitation of the invention as data may even be transferred on storage mediums between the devices or in print out form for later manual or electronic entry on a particular device.

To distribute the agent software and receive host environment information, the installation station 110 is connected to the communications network 144, e.g., the Internet. The installation system 100 may readily be utilized in very large computer networks with managed host 170, 180 servers and clients in many geographic areas. In this regard, the installation station 110 is preferably configured to remotely distribute agent software based on received host environment information. Significantly, the installation station 110 comprises an installation service device 114 that, among other functions, acts to actively and remotely manage the installation process at each managed host 170, 180. In practice, the installation service device 114 may comprise a software program or one or more application modules installed on a computer or computer system, which may be part of the installation station 110 or maintained at a separate location in communication with the installation station 110. The installation station 110 further includes memory to store payload files 118 (i.e., a set of agent software to be distributed to managed hosts 170, 180) read only site profiles 120 for each customer site (e.g., installation service device configuration 122, package and conflict definitions 124, and site policies 126), and read/write site profiles 130 for each customer site (e.g., host surveys 132, NAT mapping 134, customer information 136, and contact information 138) and a site profile viewer 140 such as a browser or other interface for viewing and/or editing site profile information from memory 120, 130.

Referring to FIG. 2, the installation service device 114 may comprise numerous components to provide the desired function of remotely managing installation sessions. As illustrated, the installation service device 114 includes a core installation manager 200 to oversee operation of the installation service device 114 such as operation of a session manager 204. A session manager 204 is provided to manage each active installation session 206, 208 at a managed host 170, 180 and specifically, to manage installation tools 174, 184 downloaded onto each host 170, 180, respectively. Interfaces are provided to interact with other components of the installation system 100. For example, an agent interface 210, an approval interface 214, and a router configuration module 218 can be provided to provide adequate communication within the installation system 100, as will be discussed in detail in connection with FIG. 3.

Referring again to FIG. 1, the installation system 100 further includes a router 150 with a NAT mapping mechanism 152 for providing and controlling allocation of IP addresses for the managed hosts 170, 180. Although a single router 150 is shown, a router can be used for each host 170, 180 and may be positioned between the communications network 144 and each host 170, 180. A remote service 160 is also included in the installation system 100 to provide ongoing monitoring functions and initial tracking and approval of the payload installation for each host 170, 180 during or after each active installation session 206, 208, respectively. In this regard, the remote service 160 includes an internal webview 162 and an IS manager 164 (for receiving requests for approval to turn on monitoring for newly installed hosts 170, 180) linked with memory 168 for storing site profile mirror files. Additionally, a NAT authority 166 mechanism is provided for tracking and authorizing IP address allocations. The operation of these components of the router 150 and the remote service 160 will be discussed in further detail in connection with the operation of the installation system 100 and FIG. 3.

As shown in FIG. 1, two managed hosts 170, 180 are included in the installation system 100 and are communicatively linked to the installation station 110, router 150, and remote service 160 via communications network 144. Two managed hosts 170, 180 are illustrated for example only, and the installation system 100 typically will include numerous hosts similar to hosts 170, 180. The managed hosts 170, 180 represent typical computer devices or systems operated by a client or customer of an operator of the remote service 160 and/or installation station 110. The operation of computing environment of the managed hosts 170, 180 is to be remotely monitored by the remote service 160 and to facilitate such remote monitoring the agent software or payload files need to be loaded on the managed hosts 170, 180 and configured to operate within the existing computing environment.

During operation of the installation system 100, a survey tool 172, 182 is loaded and executed on the managed hosts 170, 180 to remotely and automatically retrieve operating environment information useful in selecting the software payload from the payload files 118 and in configuring the selected software payload. The report or data created by the survey tool 172, 182 may be stored in memory 176, 186 as a host survey report for use during initial configuration and/or later updating. An installation tool 174, 184 is also loaded from the installation station 110 to assist in receiving, loading, and configuring the software payload from the installation station 110 and stored in agent files 178, 188.

The operation of the systems management software installation system 100 will now be discussed in detail with reference to FIGS. 1-3. Referring first to FIG. 3, exemplary functions of an automated systems management software installation and configuration 300 carried out by the installation service device 114 in conjunction with tools on the managed hosts 170, 180 are illustrated. Initially, a managed host 170, 180 is identified for addition to or for updated service by the remote service 160. The installation and configuration 300 begins at 304 with the managed host 170, 180 downloading the survey tool 172, 182. The survey tool 172, 182 may initially be in the form of a survey or discovery script obtained directly from the installation station 110 via communication with the installation service device 114 via the communications network 144, such as by an e-mail message or from a Web site operated by the installation station 110. Of course, the script may be delivered by other conventional methods, such as CD delivered by postal carrier and the like. The use of a script is useful for allowing the operator of the managed host 170, 180 to readily determine the actions that will be performed by executing the script and can decide whether these actions represent a breach of their security rules (if so, the installation station 110 is contacted to take corrective actions as necessary).

The primary purpose of the survey tool is to operate to gather environment information about the monitored host 170, 180. The environment information is utilized by the survey tool and/or the installation service device 114 to select appropriate agent software from the payload files 118 for installation on the managed host 170, 180 as agent files 178, 188. When executed at 308, the script or survey tool 172, 182 gathers the environment information and creates a file containing descriptive information for the existing environment of the managed host 170, 180 to allow selection of agent software from the payload files 118. In one embodiment, the output file of the survey tool 172, 182 is a readable XML specification of the configuration of the host 170, 180, which may be stored in the host survey report 176 for access by the host 170, 180 to further assess system security impacts of installation. The output file typically contains four main sections of environment information: host information (e.g., description of the host including existing hardware, operating system and version, software running on the host, host identifiers, and the like), specific modules that may be useful or even required to monitor detected host hardware, non-default thresholds that are calculated by the survey tool or other devices based on the host system configuration and thresholds set on each module, and actual commands to be run during installation of the payload files along with description of potential conflicts.

At 312, the survey tool 172, 182 acts to request initiation of installation by starting installation dialogue with the installation station 110 (such as through agent interface 210 of the installation service device 114). If dialogue is begun, a session manager 204 establishes an active installation session 206, 208 for each requesting host 170, 180. Note, in a preferred embodiment of the system 100, an installation station 110 is not required to execute the survey tool 172, 182. Hence, in this embodiment, it is not a fatal error for no station 110 to be detected at 312, but the survey tool 172, 182 may operate to query the operator whether the tool 172, 182 should arrange to be periodically rerun in order to complete installation steps of process 300.

Once the installation station 110 is brought online, the process 300 continues at 316 with the survey tool 172, 182 operating (either automatically or manually) to download an installation tool 174, 184 from the installation station 110. The installation tool 174, 184 is typically a software package such as a software install daemon that operates in the background of the host 170, 180 to perform various installation functions. For example, if the host 170, 180 operating system is Solaris™ the installation tool 174, 184 may be a Solaris™ package that is written in a native language (e.g., C/C++). If applicable, a newer version of the survey tool 172, 182 may be downloaded with the installation tool 174, 184. At 320, the installation tool 174, 184 retrieves or picks up the output file (e.g., the XML descriptor file) and passes a copy to the installation station 110 for storage in the host surveys file 130 and for analysis by the installation service device 114. As discussed previously, the analysis at 324 includes using the host 170, 180 environment information to select the appropriate agent software from the payload files 118 to provide a systems management software that is better suited for the existing operating environment of the host 170, 180.

Also at 324, the installation service device 114 then forwards via the session manager 204 and network 144 the agent software selected from the payload files 118. The software payload may take many forms to practice the invention and is preferably formatted to facilitate installation by the installation tool 174, 184 in the particular host 170, 180. For example, but not as a limitation, the software payload may be delivered in a format expected by a package or software installation module of the operating system of the host 170, 180 (such as pkgadd for Solaris™).

At 328, the installation tool 174, 184 operates automatically to install the received software payload on the host 170, 180 as an agent file 178. Significantly, no interaction with an operator is required during installation. In a preferred embodiment, the installation tool 174, 184 provides periodic installation progress report messages to the installation station 110 (e.g., to the session manager 204) indicating the progress of installation at various points of installation and indicating any difficulties. At 332, output from the software installation at 328 is captured in an installation report, and the installation tool 174, 184 transmits the installation report to the installation service device 114 of the installation station 110 to provide a permanent record of the install (e.g., is stored in the read only site profile 120). Note, that in some embodiments, specific threshold changes may be supplied as separate payload files which the installation tool 174, 184 can apply to the agent files (or payload software) after completion of initial installation at 328. Upon completion of installation at 328, the relevant portions of the agent software 178, 188 are started on the monitored or managed host 170, 180 and the installation tool 174, 184 reports completion of installation to the session manager 204 of the installation service device 114.

At 336, the process 300 continues with the installation service device 114 operating to inform the remote service 160 of installation of the new or discovered host 170, 180 and to seek approval for adding this new device to the monitored system (e.g., for monitoring to be turned on for the host 170, 180). The intention of the approval mechanism or acts is to provide an operator or device with the ability to delay completion of an installation until any existing errors with the host 170, 180 or payload software are assessed or other actions are taken within the remote services 160 system to insure post installation actions are successful. At 340, a query is made to a device or operator of the remote service 160 to determine if installation is approved. If not approved, the process 300 terminates at 352 with the installation service device 114 marking the host 170, 180 as denied for monitoring along with an identifier for the operator denying approval. If approved, a customer profile is generated by the by the installation station 110 (and mirrored to the remote service 160 for storage in site profile mirror 168).

Next, the post installation tool 220 is executed to verify configuration of the installed agent files 178, 188 and to verify operation of the agent files 178, 188. If post installation tool 220 determines installation was successful, a report (such as an HTML report) is generated at 348 and placed in the system 100 for viewing (e.g., in a Webview system on the installation station 110 or remote service 160) by the site profile viewer 140 or other devices remote to the station 110 (such as the internal webview 162 of the remote service 160 or the managed host 170, 180). The installation and configuration process 300 then terminates at 352.

In a preferred embodiment of the invention, the installation process 300 is completed automatically with documentation messages providing installation information being created concurrently with installation and displayed on a monitor at the managed host 170, 180. The process 300 can also be modified to include one or more manual steps to enhance operator control at the managed host 170, 180. For example, a command line option may be used to indicate after completing execution of the discovery script at 308 that installation cannot be completed. The survey tool 172, 182 then attempts to contact the installation station 110 and if successful, will request the station 110 to provide a location from which to collect a software payload. After performing a check on the available space, the survey tool 172, 182 downloads the referenced software payload (such as via anonymous ftp from the installation station 110). If the station 110 cannot be reached, the survey tool 172, 182 indicates to the operator which software packages should be downloaded and terminates execution. The software payload is manually installed and then the installation tool 174, 184 is downloaded and executed to complete the installation dialogue with the installation service device 114.

As discussed previously, the survey tool 172, 182 may be created and downloaded as a plain shell script to enable the customers or operators of the managed host 170, 180 to better understand the commands that are going to be or are being executed on their systems. The survey tool 172, 182 may contain a number of functional modules. For example, the modules may be called signatures and have specific functionality built into them to detect specific hardware or software components of a host 170, 180 computing environment. While many signatures may find use in the system 100, the following four signatures have proven useful in adequately determining a host environment: system type detection, network storage detection, cluster detection, and HA detection.

Preferably, each of these signatures can be run in one of two operating modes. First, the signatures can run in discovery only mode in which the signatures attempt to assess whether a particular component is installed and how it is configured. Second, the signatures can run in discover and baseline mode. In this second mode, the signatures act to discover a particular component and then use logic to baseline certain key thresholds that are built into the signature. This baselining model may need extended runtimes but provides the advantage of collecting reasonable thresholding information which can then be passed to the downloaded software payload or agent during initial configuration. Additionally, each signature preferably creates output (such as XML files) that is included in the output or descriptor file of the survey tool 172, 182.

According to another feature of the installation system 100, the installation system 100 is adapted to perform IP address allocation (e.g., NAT address allocation) to overcome what had previously been a barrier to successful systems management installation. NAT address allocation is achieved, at least in part, by utilizing batches of NAT addresses that are programmed into a router 150. In one embodiment, a forecast of the number of systems to be installed by the installation system 100 is generated by an operator of the system 100. Preferably, this forecast is a unique estimation rather than being tied directly to the actual number being installed. The actual mapping of the NAT addresses is managed exclusively by the installation system 100 at installation time (unless this management is hindered by constraints on the customer site such as firewall inhibition of SNMP traffic between the installation station 110 and the router 150). By managing NAT address mapping at installation time, the installation system 100 is able to overcome the problem of managed hosts 170, 180 and systems that are altered or changing which systems are to be installed between the request for installation and actual installation time. The customer merely needs to provide information for the forecast of systems to be installed within a given time period (such as the upcoming year).

In one embodiment, the installation-time management of NAT mapping is achieved by the installation service device 114 with the core installation manager 200 and the router configuration module 218. The router configuration module 218 communicates directly with the NAT mapping mechanism 152 of the router 150 and manages NAT address allocation by manipulating the router 150 using SNMP or other techniques to assign NAT addresses from a given range or batch assigned (and requesting additional batches from the NAT authority 166 when these addresses are fully allocated). Note, the approval mechanism (see items 336-344 of FIG. 3) of the system 100 is useful for allowing the router 150 programming to be completed by the installation station 110 prior to executing the post install tool 220 for the “discovered” systems. During operation of the system 100, the installation service device 114 periodically communicates with the router 150 requesting an updated NAT table of available NAT translations. The installation service device 114 saves the NAT translations locally to an XML or other format file to improve performance and simplify the system 100. During the post install execution at 344, the core installation manager 200 makes a request through the router configuration module 218 to the router 150 to associate with the NAT mapping mechanism 152 IP addresses supplied by the session manager 204 to available NAT addresses (typically, using conventional SNMP calls).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. Specifically, the installation service device 114 should be recognized as a significant feature of the installation system 100 that is continually running and in communication with the other components of the system 100 awaiting survey script and installation initiation requests. Only one installation station 110 is shown, but many may be provided within a system 100 (such as one located at each customer site having multiple hosts 170, 180). While only two hosts 170, 180 were illustrated and discussed, the installation service device 114 preferably is adapted for managing many simultaneous installations and to queue any beyond a predetermined limit (such as 100 simultaneous installations). Typically, any interface (such as a GUI or command line interface) may be utilized to control and view the installation service device operation and such interfaces are considered part of the breadth of the invention.

We claim:

1. A method for installing systems management software on a host device to be remotely monitored, comprising:
communicatively linking an installation station and the host device, wherein the host device is positioned remote from the installation station;
receiving over the communication link at the installation station computing environment information for the host device;
loading an installation tool configured to automatically install the systems management software on the host device;
transmitting a software payload comprising the systems management software from the installation station to the host device;
first operating the installation tool to automatically install the software payload on the host device; and
second operating the installation tool to automatically configure the installed software payload based on the computing environment information.

2. The method of claim 1, wherein the computing environment information includes information selected from the group consisting of host information, identification of modules for monitoring the host device, thresholds based on configuration of the host device, and installation commands to run during the first operating.

3. The method of claim 1, further including loading a survey tool on the host device and running the survey tool to automatically gather the computing environment information.

4. The method of claim 3, further including prior to the installation tool loading and the survey tool loading, transmitting the installation tool and the survey tool from the installation station to the host device.

5. The method of claim 3, wherein the survey tool is configured to create an extensible markup language (XML) descriptor file including the computing environment information.

6. The method of claim 1, further including providing the installation station with access to a data storage device storing differing ones of the systems management software and with the installation station, selecting the software payload from the differing ones based on the received computing environment information.

7. A method of deploying systems management software within a network including multiple managed hosts, comprising:
positioning an installation station within the network, wherein the installation station includes data storage for storing the systems management software and is in communication with a first and a second one of the managed hosts;
at the first and the second ones, downloading a survey tool from the installation station;
executing the downloaded survey tools to gather environment information for the first and second ones and to create output files comprising the gathered environment information;
at the first and the second ones, downloading an installation tool from the installation station;
transmitting the output files from the first and second ones to the installation station;
in response to receiving the output files, transferring a payload of the systems management software to the first and second ones; and
at the first and second ones, installing the transferred payloads with the installation tool.

8. The method of claim 7, wherein the survey tool downloading, the executing, the installation tool downloading, the transmitting, and the installing occur at least partially concurrently at the first and the second ones of the managed hosts.

9. The method of claim 8, further including transmitting from the first and second ones an installation initiation request to the installation station and in response to receiving the installation requests, establishing with the installation station a first active installation session and a second active installation session for remotely and concurrently managing the transferring and the installing of the payloads.

10. The method of claim 7, wherein the gathered environment information for the first one differs from the gathered environment information for the second one and further including prior to the transferring, selecting a first portion of the systems management software for inclusion in the payload to the first one based on the gathered environment information and selecting a second portion of the systems management software for inclusion in the payload to the second one based on the gathered environment information.

11. The method of claim 10, further including after the installing of the transferred payloads, configuring the installed payloads at the first and second ones based on the differing environment information.

12. The method of claim 7, further including allocating network addresses to network devices associated with the first and second ones.

13. The method of claim 12, wherein the network address allocating is performed at least partially concurrently with the installing and wherein network addresses are selected from network addresses preprogrammed into a router based on a forecasted number of the associated network devices.

14. A networked method for automatically deploying and installing agent software in a network computer device, comprising:
communicatively linking an installation station via a communications network to the network computer device;
downloading a survey script from the installation station onto the network computer device;
executing the survey script to automatically create an output file defining a computing environment for the network computer device;
downloading an installation Daemon from the installation station onto the network computer device;
using the installation Daemon to retrieve the output file and transfer a copy of the output file to the installation station;
in response to receiving the copy, transferring the agent software to the network computer device over the communications network; and
automatically installing the agent software on the network computer device with the installation Daemon.

15. The method of claim 14, further including performing modifications of the installed agent software based on the output file to enhance operation of the installed agent software.

16. The method of claim 14, wherein the output file includes information selected from the group consisting of network computer device hardware and software configuration information, identification of modules for monitoring the network computer device, thresholds based on configuration of the network computer device, and installation commands for the installation Daemon to run during the installing.

17. The method of claim 14, wherein the installation Daemon is adapted to create progress messages during the installing and wherein the progress messages are accessible by the network computer device.

18. A network system for remotely monitoring an operating computer system, comprising:
a managed host in the operating computer system linked to a communications network, the managed host including a survey tool for automatically gathering environment information and an installation tool for transmitting the environment information over the communications network and for automatically installing systems management software on the managed host; and
an installation station linked to the communications network configured to receive the environment information and in response to transmit a payload of the systems management software to the managed host.

19. The system of claim 18, wherein the installation tool is further configured to modify the installed systems management software based on the environment information.

20. The system of claim 18, wherein the installation station processes the environment information to select the payload to match the environment information.

21. The system of claim 18, further including a remote service linked to the communications network and operable to monitor operations of the computer system via execution of the installed systems management software on the managed host.

22. The system of claim 21, wherein the installation tool functions to generate an installation report and transmit the installation report to the installation station, wherein the installation station functions in response to the installation report to transmit a request for approval of adding the managed host to the network system to the remote service, and wherein the remote service responds to the request for approval by determining whether to begin monitoring the managed host.
